(19) United States
(12) Patent Application Publication
(10) Pub. No.: US 2004/0168958 A1
(43) Pub. Date: Sep. 2, 2004

(54) Fall thru sand trap

(76) Inventor: Allen A. Eggleston, Sumter, SC (US)

Correspondence Address: ALLEN A. EGGLESTON, 258 PACK RD., SUMTER, SC, 29150, US

(21) Appl. No.: 10/726,906

(22) Filed: Dec. 4, 2003

Related U.S. Application Data
(60) Provisional application No. 60/441,174, filed on Jan. 21, 2003.

(51) Int. Cl. B01D 35/14

(52) U.S. Cl. 210/95; 210/411; 210/459

(57) ABSTRACT

The-FALL THRU SAND TRAP employs a screen, open top and bottom to allow sand and debris to fall away from the filter. A transparent holding pipe, sight glass, holding pipe, and a method to back flush.

### BACKGROUND OF INVENTION

This invention relates to a type of filter to remove foreign objects from fluids, such as water systems, irrigation systems, domestic water supply, industrial water supply, water source heat pumps, etc. It employs a filtering system and a unique trap to hold particles until it is purged. It has an efficient backwash method to clean the filter screen. Other in line filters, as the screen in housing type, hold sand in suspension in the housing, as water flows through the filter it agitates the sand, thus breaking it up into smaller pieces, until it passes through the screen rendering the filter processing ineffective. String wound and cartridge type filters, plug fast, causing a pressure drop, and are expensive and inconvenient to replace. The fall thru sand trap allows sand to fall out of the main flow and be collected for more efficient operation, and is easy to purge.

### DESCRIPTION OF THE FOUR VIEWS OF THE DRAWINGS

FIG. 1: Shows the FALL THRU SAND TRAP side view in the normal flow position. Proper positioning of the on/off valves, directing the inlet water through the filter and to the outlet of the filter.

FIG. 2: Shows the fall thru sand trap side view in the purge flow position. Proper positioning of the on/off valves for the purging of the filter.

FIG. 3: Shows a side and top view of the fall thru sand trap detailing a breakdown of parts.

FIG. 4: Shows an exploded view of the internal construction of the filter screen sealed to the threaded portion of the male adapter.

### DETAILED DESCRIPTION OF THE INVENTION

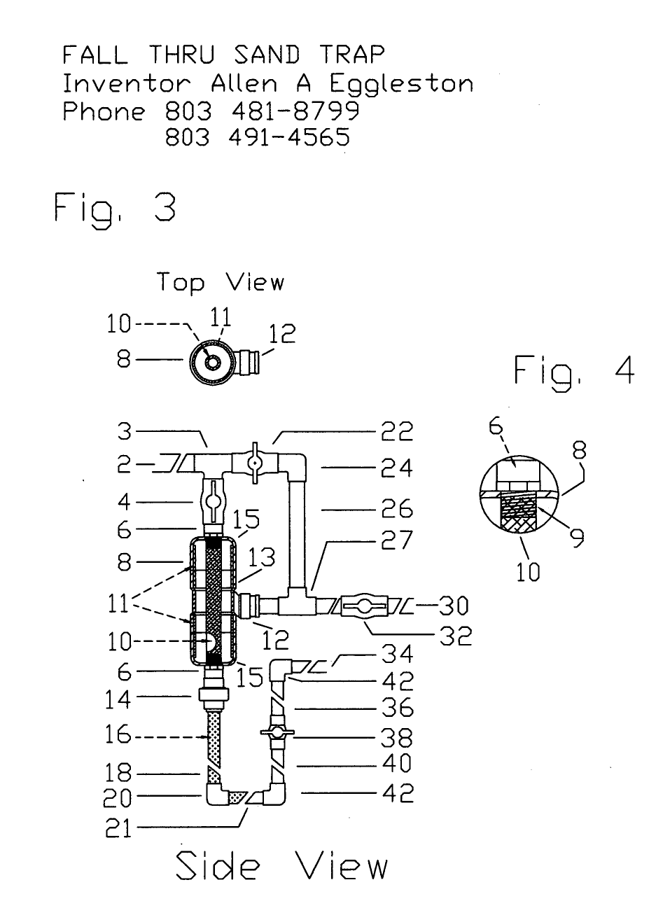

FIG. 3: The FALL THRU SAND TRAP is built from plastic pipe and fittings.

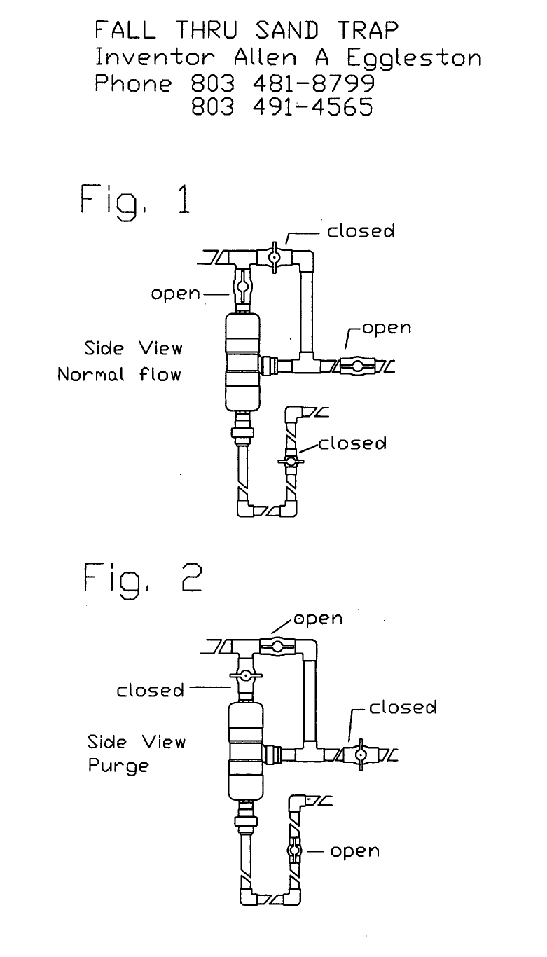

FIG. 1: shows an overall view of the FALL THRU SAND TRAP with the on/off valves in the normal flow position. Pipe end caps 15, make up the ends of the housing. A standard DWV (drain waste vent) fitting 13 is the middle part of the filter housing. The caps15, are joined to the DWV fitting by a piece of plastic pipe 11, cut to fit and cemented in place.

Fluid enters into the inlet 2, then directed through a inlet tee 3, into the inlet valve 4, and into the housing 8, a male adapter 6 connects the inlet valve 4 into the top of the housing 8 by drilling, threading and cementing the male adapter into the top of the housing. An stainless steel wire cloth is formed into a tubular cylinder, forming a tubular filter screen 10, extending from the top inside of the housing to the bottom inside of housing 8, and secured by over lapping the filter over the threads of the male adapter 6, and sealed with a sealent 9 in place to make water tight as shown in FIG. 4: Contaminated fluid enters the filter, into the inside of the filter 10 and passes through the filter mesh from inside, outwards to the outlet 12 into the open outlet valve 32, to the discharge of the filter 30. Trapped particles 16 fall downward through the inside of the filter screen, through the pipe union 14 into the trap18. The trap pipe is transparent and doubles as a sight glass to determine when the FALL THRU SAND TRAP needs to be purged. Particles 16 are held in suspension by the closed dump valve 38. Fittings 20 and 42 are typical pipefittings, as well as pipe 21, installed inline to the configuration of the installation of the FALL THRU SAND TRAP. Pipe 40, is mounted vertical as to maintain a clear water head against the dump valve 38 to prevent small particles from jamming the packing and premature wearing out the dump valve 38.

Purge: FIG. 2: shows an overall view with the on/off valves in the purge position. When looking at the sight glass trap 18, and a significant amount of debris 16, is collected, opening the dump valve 38 cleans out trapped particles. Water pressure will blow out any debris through the discharge pipe 34. When a more thorough back washing is needed, as a low-pressure situation, or shuleded maintance, the dump valve 38 is opened. The shut off valve 32 is closed, the inlet valve 4 is closed, and the purge valve 22 is opened. Fluid is then directed from the inlet 2 through the open purge valve 22, through the elbow 24, through the pipe 26, through the tee 27, and backwards into the housing, fluid pressure pushes any particles from outside the filter screen inward to the inside of the filter screen and out the discharge pipe. Additional cleaning can be done by unscrewing the union 14, moving the sight glass trap out of the way and using a bottle brush to scour the inside of the filter mesh.

1. What I claim as my invention is the unique fall through design of the method, for separating impurities from fluids, such as sand particles, rust flakes, shell particles, etc.. Combined with the incorporated transparent holding pipe and trap that holds debris until purging, combined with the incorporated method of purging, by redirecting the flow of fluid to back flush the filter screen.
